(19) United States
(12) Patent Application Publication
(10) Pub. No.: US 2006/0200588 A1
(43) Pub. Date: Sep. 7, 2006

(54) Method and apparatus for determining load of input/output command in input/output subsystem

(75) Inventors: You-jip Won, Seongnam-si (KR); Jun-seok Shim, Seongnam-si (KR); Boldyrev Serguei, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/346,377

(22) Filed: Feb. 3, 2006

(30) Foreign Application Priority Data
Feb. 4, 2005 (KR) 10-2005-0010863

(51) Int. Cl. G06F 3/00

(52) U.S. Cl. 710/5

(57) ABSTRACT

A method and apparatus for determining the load of an input/output command in an input/output subsystem are provided. The method for determining the load of an input/output command in a system for inputting/outputting data to/from a disk sector according to an input/output command provided from a disk driver includes: (a) extracting the input/output commands for inputting/outputting the data to/from the disk sector from the disk driver and generating a set of input/output commands from the input/output commands; (b) analyzing the load feature of the input/output command based on the set of input/output commands; and (c) determining whether the load of the input/output command corresponds to a multimedia application based on the load feature of the input/output command.

### CROSS-REFERENCE TO RELATED PATENT APPLICATION

This application claims priority from Korean Patent Application No. 10-2005-0010863, filed on Feb. 4, 2005, in the Korean Intellectual Property Office, the disclosure of which is incorporated herein in its entirety by reference.

### BACKGROUND OF THE INVENTION

1. Field of the Invention

The present invention relates to a method and apparatus for reading data of a disk in a disk transfer system, which may be an input/output subsystem, and more particularly, to a method and apparatus for analyzing a load feature of a data transfer command of an application, which may be an input/output command, and determining whether the load of the data transfer command corresponds to a multimedia application.

2. Description of the Related Art

Disks have performed the important function of storing data in everything from mainframes to laptop computers for the past 30 years. In the past, the main concern about disks was their data storage capacity. However, since this has been sufficiently increased in recent years, the intelligence of the disk has become a focus, to allow it to perform the role of the input/output subsystem.

FIG. 1 is a functional block diagram of a general input/output subsystem. The input/output subsystem includes an application layer 110, a file system layer 120, a disk driver layer 130 and a disk 140.

An operating system receives a file name input by a user from the application layer 110, which is an upper layer of the operating system, and retrieves the file name from a whole directory which is managed by itself. In the operating system, the input file is identified using file identification information called a file descriptor.

The storage space of the disk includes spatial components such as a track and a sector, and the file system layer 120 performs the role of organizing the spatial components into a linear array of logical blocks. In the general file system layer, each file is connected with a data structure, which is called an inode and has file related information such as the location, the last update time, and the access mode of the logical block in which the data is stored. The file system layer 120 retrieves the inode connected with the file which is a target of the input/output operation from the file descriptor which is received from the operating system, fetches the file related information from the inode, and performs the input/output operation.

The disk driver layer 130 connects the disk 140 to the operating system. The logical block number which is output as the result of the input/output operation is delivered to the disk driver layer 130. Since the disk 140 does not recognize the logical block number, the disk driver layer 130 converts the logical block number into physical spatial information such as a cylinder, a track and a sector, and delivers it to the disk 140. The disk 140 performs the input/output operation using the physical spatial information.

The general input/output subsystem inputs/outputs the data to/from the disk 140 according to the input/output command received from the disk driver layer 120, whether the file which is the target of the input/output command is a text file or a multimedia file.

Information electronic devices having a computer function such as information processing, transmission and storage have a specialized load of the input/output command, such as recording or playback of multimedia data such as video files and music files, unlike a general-purpose computer.

A method and apparatus for determining whether the load of the input/output command corresponds to the multimedia application, such that the optimal disk schedule corresponding to the multimedia application is set and the operating system is optimally controlled in correspondence with the multimedia application, is required in the input/output subsystem.

### SUMMARY OF THE INVENTION

The present invention provides a method for analyzing a load feature of a data transfer command, which includes an input/output command, extracted from a disk driver and determining whether the load of the input/output command corresponds to a multimedia application according to the analyzing result.

The present invention also provides an apparatus for analyzing a load feature of an input/output command extracted from a disk driver and determining whether the load of the input/output command corresponds to a multimedia application according to the analyzing result.

According to an aspect of the present invention, there is provided a method for determining the load of an input/output command in a system for inputting/outputting data to/from a disk sector according to an input/output command provided from a disk driver, including: (a) extracting the input/output commands for inputting/outputting the data to/from the disk sector from the disk driver and generating a set of input/output commands from the input/output commands; (b) analyzing the load feature of the input/output command based on the set of input/output commands; and (c) determining whether the load of the input/output command corresponds to a multimedia application based on the load feature of the input/output command.

The operation (a) may include: (a1) extracting the input/output commands for inputting/outputting the data to/from the disk sector from the disk driver to store them during a first time; and (a2) generating the set of input/output commands composed of recent input/output commands during a second time from among the input/output commands stored during the first time.

The operation (b) may include: extracting the load features of the input/output commands from the set of input/output commands; and calculating a statistic of the load features of the input/output commands from the load features of the input/output commands and analyzing the load feature of the input/output command.

The operation (c) may include: classifying the load feature of the input/output command from the statistic of the load features of the input/output commands by a classifying unit generated by learning the input/output command of the multimedia application; and determining whether the load of the input/output command corresponds to the multimedia application, based on the classification of the classifying unit.

According to another aspect of the present invention, there is provided an apparatus for determining the load of an input/output command in a system for inputting/outputting data to/from a disk sector according to an input/output command provided from a disk driver, including: an extracting unit which extracts the input/output command for inputting/outputting the data to/from the disk sector from the disk driver and generates a set of input/output commands from the extracted input/output command; an analyzing unit which analyzes the load feature of the input/output command based on the set of input/output commands; and a determining unit which determines whether the load of the input/output command corresponds to a multimedia application based on the load feature of the input/output command.

The extracting unit may include: a storing unit which stores the input/output commands for inputting/outputting the data to/from the disk sector during a first time; and a generating unit which generates the set of input/output commands composed of recent input/output commands during a second time from among the input/output commands stored during the first time.

The generating unit may include: a first extracting unit which extracts the input/output commands and stores them in the storing unit; an updating unit which removes the oldest input/output command from the input/output commands stored during the first time and adds a new input/output command to the input/output commands during the first time to update the input/output commands during the first time, if the new input/output command is requested from the disk driver; and an input/output command set generating unit which generates the set of input/output commands composed of the recent input/output commands during the second time from among the updated input/output commands.

The analyzing unit may include: a second extracting unit which extracts the load features of the input/output commands from the set of input/output commands; and a calculating unit which calculates a statistic of the load features of the input/output commands from the load features of the input/output commands.

The determining unit may include: a classifying unit which classifies the load feature of the input/output command based on the learning result and the statistic of the load features of the input/output commands; and a load determining unit which determines whether the load of the input/output command corresponds to the multimedia application based on the classification of the classifying unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a functional block diagram of a general input/output subsystem;

FIG. 2 is a functional block diagram of an apparatus for determining the load of a data input/output command according to an exemplary embodiment of the present invention;

FIG. 3 is a functional block diagram of an extracting unit and an analyzing unit of the apparatus for determining the load of a data input/output command shown in FIG. 2;

FIG. 4 is a functional block diagram of a determining unit of the apparatus for determining the load of a data input/output command shown in FIG. 2;

FIG. 5 is a flowchart showing a method for determining the load of a data input/output command according to an embodiment of the present invention;

FIG. 6 is a flowchart of an operation for generating a set of input/output commands and an operation for analyzing the feature of the

FIG. 7 is a flowchart of an operation for determining whether the load of the input/output command corresponds to a multimedia application in FIG. 5;

FIGS. 8 A-M show a set of input/output commands of a plurality of multimedia applications, that is, a trace of the input/output commands; and

FIG. 9 is a table showing the characteristics of the trace of the input/output commands of the multimedia player shown in FIG. 8.

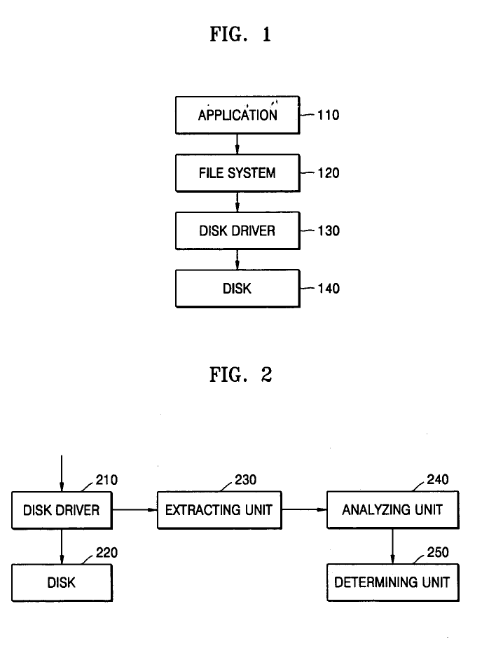

### DETAILED DESCRIPTION OF THE INVENTION

FIG. 2 is a functional block diagram of an apparatus for determining the load of a data input/output command according to an embodiment of the present invention. The apparatus for determining the load of the data input/output command includes an extracting unit 230, an analyzing unit 240 and a determining unit 250.

The disk driver 210 includes a first memory (not shown) for storing the input/output command delivered to the disk 220. An extracting unit 230 extracts the input/output command delivered to the disk 220 from the disk driver 210. The input/output command extracted by the extracting unit 230 is stored in a second memory (not shown) included in the extracting unit 230. Whenever a new input/output command is delivered to the disk 220 from the disk driver 210, the extracting unit 230 removes the oldest input/output command from the second memory and stores the new input/output command in the second memory to update the input/output commands. A set of input/output commands (referred to as a trace of the input/output commands) is generated from the updated input/output commands and is provided to the analyzing unit 240.

The analyzing unit 240 analyzes the load feature of the input/output command delivered to the disk 220 from the disk driver 210. The analyzing unit 240 extracts the load features of the input/output commands from the set of input/output commands and calculates a statistic of the load features of the input/output commands from the load features of the input/output commands.

The determining unit 250 determines whether the load of the input/output command corresponds to the multimedia application, based on the load feature of the input/output command analyzed by the analyzing unit 240.

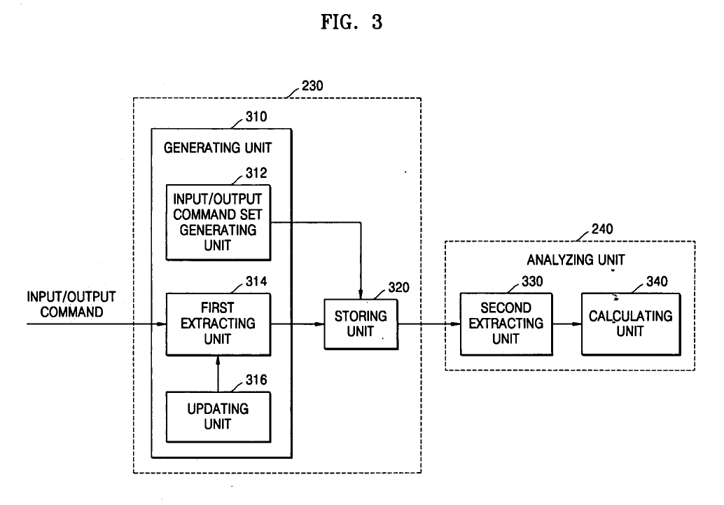

FIG. 3 is a functional block diagram of the extracting unit 230 and the analyzing unit 240 according to an embodiment of the present invention. The extracting unit 230 includes a generating unit 310 and a storing unit 320, and the analyzing unit 240 includes a second extracting unit 330 and a calculating unit 340.

First, the extracting unit 230 will be described. The generating unit 310 of the extracting unit 230 generates a set of the most recent input/output commands during a second time from among the stored input/output commands. The generating unit 310 includes an input/output command set generating unit 312, a first extracting unit 314 and an updating unit 316. The first extracting unit 314 extracts the input/output command delivered to the disk 220 from the disk driver 210. The extracting unit 230 includes a storing unit 320 for storing the input/output commands extracted by the first extracting unit 314 during a first time.

When a new input/output command is requested from the disk driver 210 to the disk 220, the updating unit 316 removes the oldest input/output command from the input/output commands during the first time and adds the new input/output command to the input/output commands during the first time to update the input/output commands during the first time. The input/output command set generating unit 312 generates a set of input/output commands composed of the input/output commands during a second time from the input/output commands during the first time which is updated by the updating unit 316.

According to the application field of the present invention, the storing unit 320 may be composed of a first storing unit (hereinafter, referred to as a free-list) which is a set of usable storage spaces, and a second storing unit (hereinafter, referred to as a used-list) which is a set of used storage spaces. The input/output commands during the first time extracted by the first extracting unit 314 are stored in the used-list. When a new input/output command is extracted, the updating unit 314 fetches the storage space from the free-list to store the new input/output command therein, and connects the storage space to the used-list. Also, the updating unit 316 removes the oldest input/output command from the used-list and returns the storage space in which the removed input/output command was stored to the free-list. The input/output command set generating unit 312 generates a set of input/output commands composed of recent input/output commands during the second time, from among the input/output commands stored in the used-list. According to the application field of the present invention, the period of the first time may be equal to the period of the second time. This is included in the scope of the present invention.

According to the application field of the present invention, the storing unit 320 may be mass storage medium connected by a general-purpose interface. In this case, the input/output commands extracted by the first extracting unit 314 are continuously stored in the storing unit 320, and the input/output command set generating unit 312 generates a set of input/output commands composed of recent input/output commands during the second time, from among the input/output commands stored in the storing unit 320.

The analyzing unit 240 includes the second extracting unit 330 and the calculating unit 340, and analyzes the load feature of the input/output command based on the set of input/output commands. The second extracting unit 330 extracts the load feature of the input/output command which composes the set of input/output commands. The input/output command delivered to the disk 220 from the disk driver 210 includes information for inputting/outputting the data which is requested for executing a file in a predetermined application to/from the sector of the disk 220. The second extracting unit 330 extracts the load feature of the input/output command, for example, an input/output request time, the number of input/output sectors, and the location of the input/output sectors, from the information.

The calculating unit 340 calculates the statistic of the load features of the input/output commands. The statistic of the load features of the input/output commands represents the loads of the input/output commands delivered to the disk 220 from the disk driver 210, and may be the average of the input/output request time intervals, the standard deviation, the median, the range of input/output request time internals, the number of the sectors read during a unit of time, and the number of input/output commands during a unit of time.

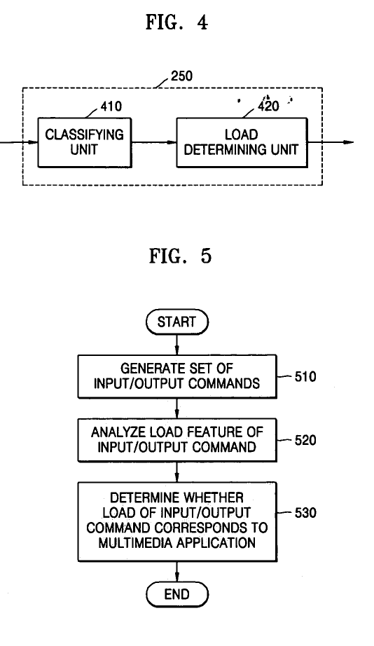

FIG. 4 is a functional block diagram of the determining unit 250 according to an embodiment of the present invention. The determining unit 250 includes a classifying unit 410 and a load determining unit 420.

The classifying unit 410 classifies the loads of the input/output commands based on the statistic of the input/output commands. The classifying unit 410 is manufactured based on the learning result generated by learning the load feature of the input/output command of at least one multimedia application.

When at least one multimedia application such as mpeg2dec, xine or mplayer executes at least one multimedia file such as low quality news, high quality news, low quality music video or high quality music video, the material relating to the input/output request time during a unit of time and the number of input/output sectors is extracted. An input variable is generated using the extracted material. The input variable is the average of the input/output request time intervals, the standard deviation, the median, the range of input/output request time intervals, the number of sectors read during a unit of time, and the number of input/output commands during a unit of time, which are calculated from the extracted material. The calculated input variable is input to a boosting algorithm, where it is used to generate a decision tree.

The classifying unit 410 classifies whether the set of input/output commands corresponds to the multimedia application, based on the decision tree generated by a learning device. That is, the classifying unit 410 receives the statistic of the set of input/output commands and classifies whether the load of the input/output command corresponds to the multimedia application, based on the decision tree.

According to the application field of the present invention, the load feature of the input/output command of the multimedia application can be learned by another learning method, such as a Baysian learning, neural network or support vector machine method. These are included in the present invention.

The load determining unit 420 determines whether the load of the input/output command corresponds to the multimedia application, based on the classification of the classifying unit 410.

FIG. 5 is a flowchart showing a method for determining the load of a data input/output command according to an exemplary embodiment of the present invention.

In the method for determining the load of a data input/output command, an input/output command for inputting/outputting the data of the disk sector is extracted from the disk driver, and a set of input/output commands is generated from the extracted input/output command (operation 510). The load feature of the input/output command is extracted from the set of input/output commands, and a statistic of the load features is calculated to analyze the load feature of the input/output command (operation 520). It is determined whether the load of the input/output command corresponds to the multimedia application, based on the load feature of the input/output command (operation 530).

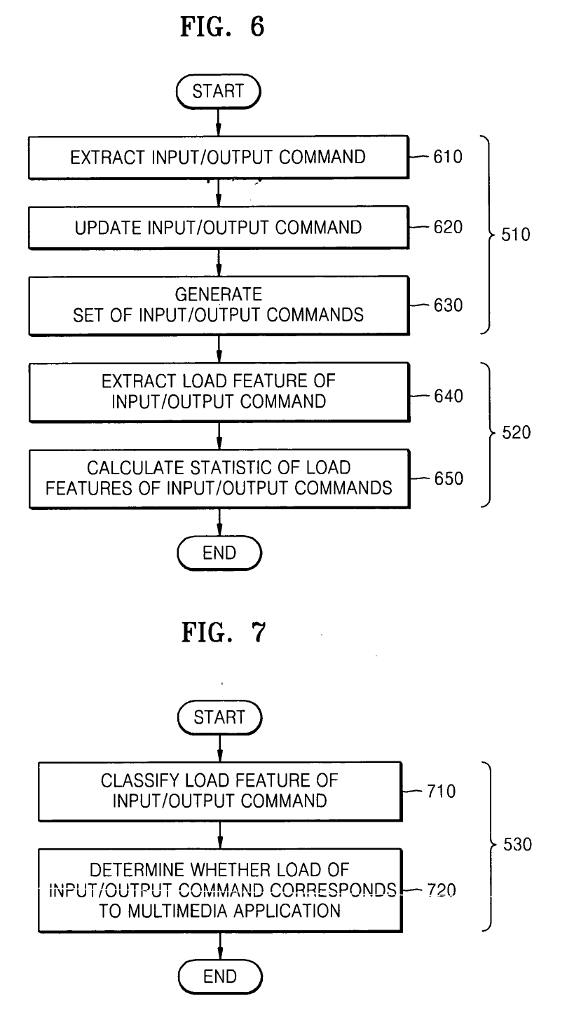

FIG. 6 is a flowchart of an operation 510 for generating the set of input/output commands, and an operation 520 for analyzing the load feature of the input/output command. The input/output command for inputting/outputting the data to/from the disk sector is extracted from the disk driver (operation 610). The extracted input/output command is stored in the storing unit during a first time. If a new input/output command is delivered from the disk driver to the disk, the oldest input/output command is removed from the input/output commands during the first time and the new input/output command is added to the input/output commands during the first time. That is, whenever a new input/output command is delivered, the input/output commands during the first time are updated (operation 620). A set of input/output commands composed of the input/output commands during the second time is generated from the updated input/output commands during the first time (operation 630). Operations 610 through 630 together form operation 510.

The load features of the input/output commands, such as the input/output request time of the input/output command, the number of input/output sectors, and the location of the input/output sectors, are extracted from the set of input/output commands (operation 640). The statistic of the loads of the set of input/output commands is calculated from the load features of the input/output commands (operation 650). The statistic may be the average of the input/output request time intervals, the standard deviation, the median, the range of input/output request time internals, the number of sectors read during a unit of time, and the number of input/output commands during a unit of time. Operations 640 and 650 together form operation 520. According to the application field of the present invention, different types of load feature of the input/output command and the statistic of the loads of the input/output commands may be used. These are all included in the scope of the present invention.

FIG. 7 shows an operation 530 for determining whether the load of the input/output command corresponds to a multimedia application. The load features of the input/output commands are classified from the statistic of the load features of the input/output commands by the classifying unit generated by learning the input/output command of the multimedia application (operation 710). It is determined whether the load of the input/output command corresponds to the multimedia application based on the classification of the classifying unit (operation 720).

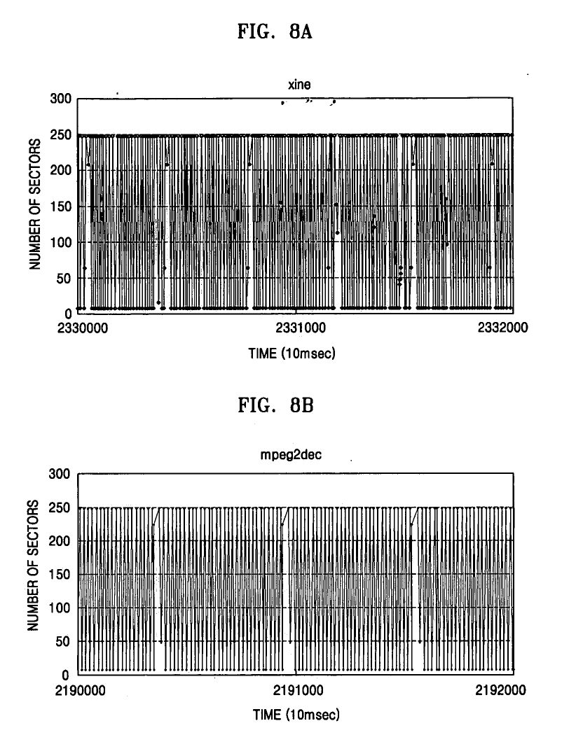

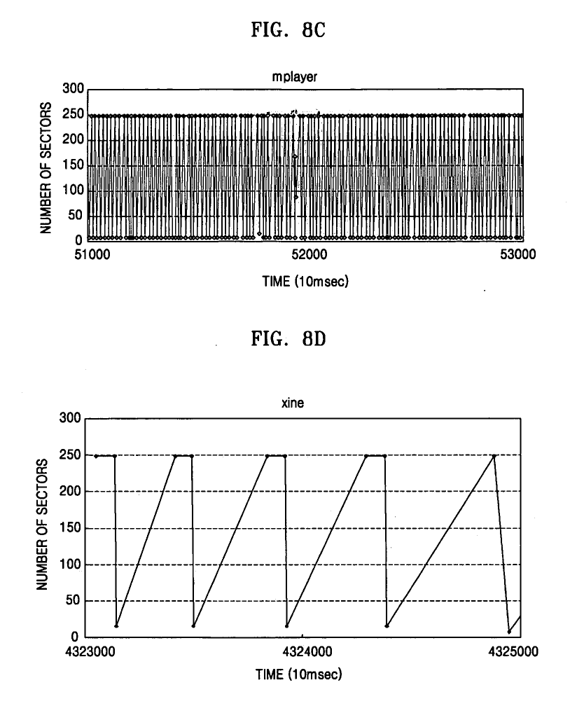

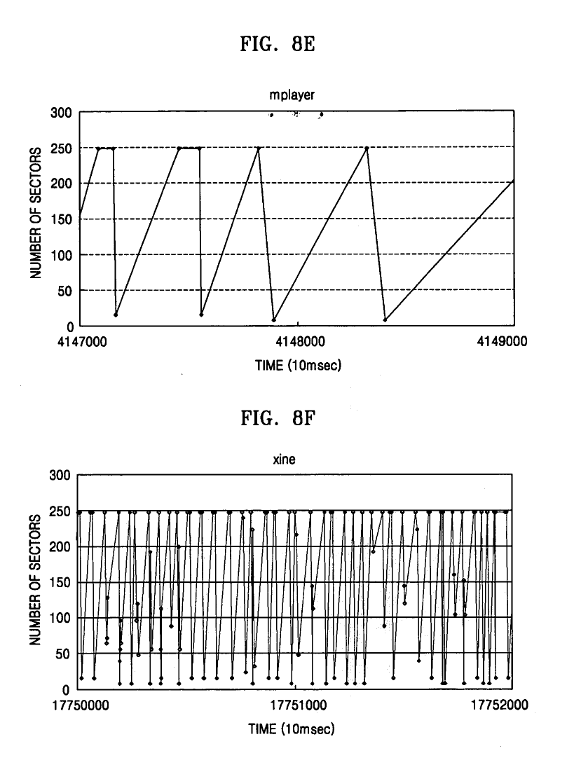

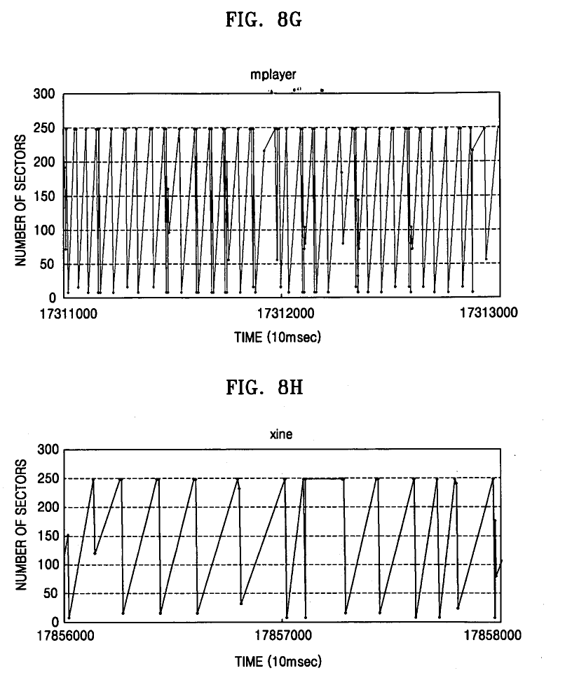

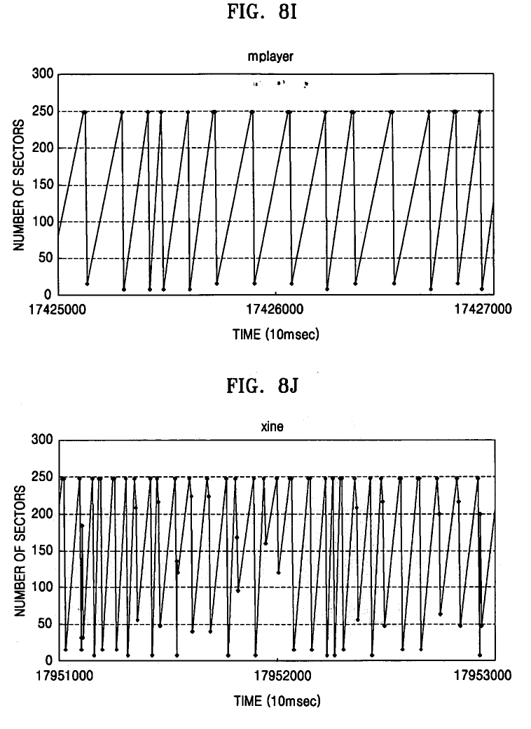

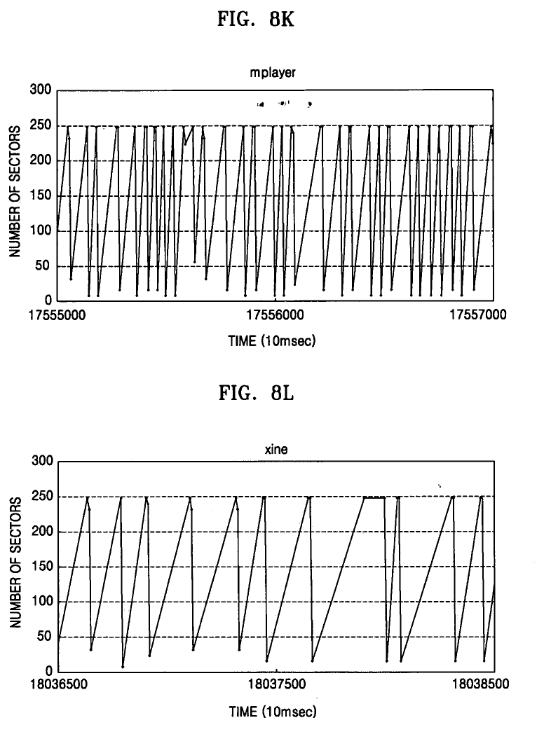

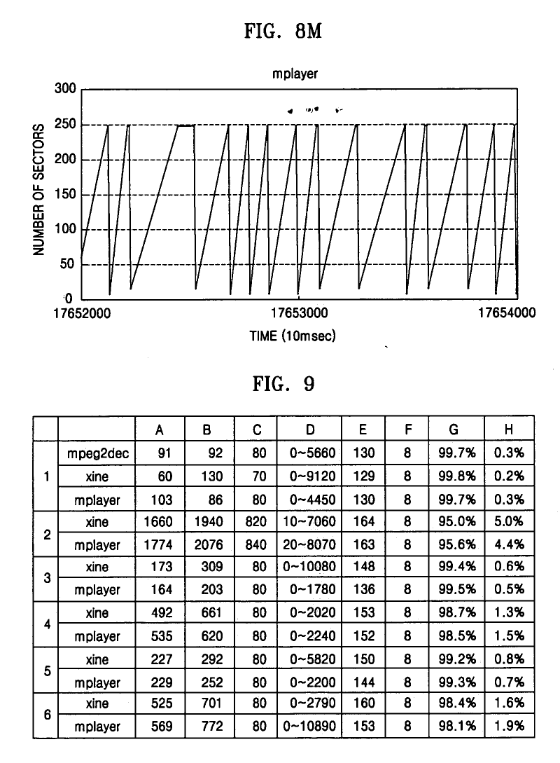

Hereinafter, referring to FIGS. 8 and 9, the common features of the input/output command of the multimedia application which is learned so as to manufacture the classifying unit will be described.

FIGS. 8A through 8M show a set of input/output commands, that is, a trace of the input/output commands of the plurality of multimedia applications. FIGS. 8A through 8M show the form that the plurality of the multimedia applications which are widely used, for example, xine, mpeg2dec or mplayer, access the disk. The X axis indicates a time of the input/output command accession and the Y axis indicates the number of sectors of the input/output commands which are delivered to the disk.

FIG. 8A shows the trace of the input/output commands of the high quality news which is reproduced at 8.76 Mb/s in xine, FIG. 8B shows the trace of the input/output commands of the high quality news which is reproduced at 8.76 Mb/s in mpeg2dec, FIG. 8C shows the trace of the input/output commands of the high quality news which is reproduced at 8.76 Mb/s in mplayer, FIG. 8D shows the trace of the input/output commands of the low quality news which is reproduced at 0.38 Mb/s in xine, FIG. 8E shows the trace of the input/output commands of the low quality news which is reproduced at 0.38 Mb/s in mplayer, FIG. 8F shows the trace of the input/output commands of the high quality music video which is reproduced at 1.18 Mb/s in xine, FIG. 8G shows the trace of the input/output commands of the high quality music video which is reproduced at 1.18 Mb/s in mplayer, FIG. 8H shows the trace of the input/output commands of the low quality music video which is reproduced at 0.67 Mb/s in xine, FIG. 81 shows the trace of the input/output commands of the low quality music video which is reproduced at 0.67 Mb/s in mplayer, FIG. 8J shows the trace of the input/output commands of the high quality music video which is reproduced at 2.60 Mb/s in xine, FIG. 8K shows the trace of the input/output commands of the high quality music video which is reproduced at 2.60 Mb/s in mplayer, FIG. 8L shows the trace of the input/output commands of the low quality music video which is reproduced at 1.16 Mb/s in xine, and FIG. 8M shows the trace of the input/output commands of the low quality music video which is reproduced at 1.16 Mb/s in mplayer. (The information in this paragraph would be much more accessible in the form of a table.)

FIG. 9 is a table showing the characteristics of the trace of the input/output commands of the multimedia player shown in FIGS. 8A through 8M. Here, 1 through 6 respectively indicate 8.76 Mb/s high quality news, 0.38 Mb/s low quality news, 1.18 Mb/s high quality music video, 0.67 Mb/s low quality music video, 2.60 Mb/s high quality music video, and 1.16 Mb/s low quality music video. Also, A through H indicate the average intervals between the timings of the read request accession (ms), the standard deviation of the intervals between the timings of the read request accession (ms), the median of the intervals between the timings of the read request accession (ms), the range of the intervals between the timings the read request accession (ms), the average of the read request sizes (the number of sectors), the average of the write request sizes (the number of sectors), a read request ratio (%), and a write request ratio (%).

Referring to FIGS. 8 and 9, the input/output commands of the multimedia players such as xine, mplayer and mpeg2dec have different features according to the kind of multimedia player and the quality of the moving image, but have the following common features.

First, a certain amount of data is periodically requested to the disk. Second, all the multimedia players have the trace of the input/output commands which repeatedly generate the input/output request having continuous 248 or 8 sectors. This is generated because the multimedia files are continuously stored in the disk. Third, the multimedia player reads a multimedia file, but the write operation for periodically updating the inode of the file is also generated.

As shown in FIGS. 8 and 9, the input/output commands of the multimedia applications have common features. Since the classifying unit can check these common features, it can determine whether the load of the input/output command corresponds to the multimedia application.

The embodiments of the present invention can be written as computer programs and can be implemented in general-use digital computers that execute the programs using a computer readable recording medium. Examples of the computer readable recording medium include magnetic storage media (e.g. ROM, floppy disks, hard disks, etc.), optical recording media (e.g. CD-ROMs, or DVDs), and storage media such as carrier waves (e.g. transmission through the internet).

According to the method and apparatus for determining the load of the input/output command of the present invention, the optimal disk schedule is set in correspondence with the multimedia application, and it is determined whether the load of the input/output command corresponds to the multimedia application such that the input/output command is optimally controlled to correspond to the multimedia application.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for determining the load of a data transfer command in a system for transferring data to/from a disk sector according to a data transfer command provided from a disk driver, comprising:
(a) extracting the data transfer commands for transferring the data to/from the disk sector from the disk driver, and generating a set of data transfer commands from the data transfer commands;
(b) analyzing the load feature of the extracted data transfer command based on the generated set of data transfer commands; and
(c) determining whether the load of the data transfer command corresponds to a multimedia application based on the analyzed load feature of the data transfer command.

2. The method according to claim 1, wherein operation (a) comprises:
(a1) extracting the data transfer commands for transferring the data to/from the disk sector from the disk driver and storing them during a first time; and
(a2) generating the set of input/output commands composed of the most recent data transfer commands during a second time from among the data transfer commands stored during the first time.

3. The method according to claim 2, wherein operation (a1) comprises:
extracting the data transfer commands for transferring the data to/from the disk sector from the disk driver;
storing the extracted data transfer commands during the first time; and
if a new data transfer command is requested from the disk driver, removing the oldest data transfer command from the data transfer commands stored during the first time and extracting the new data transfer command to add the new data transfer command to the data transfer commands during the first time.

4. The method according to claim 3, wherein the period of the first time and the second time are equal to each other.

5. The method according to claim 2, wherein operation (b) comprises:
extracting the load features of the data transfer commands from the set of data transfer commands; and
calculating a statistic of the load features of the data transfer commands from the load features of the data transfer commands and analyzing the load feature of the data transfer command.

6. The method according to claim 5, wherein the load feature of the data transfer command is a data transfer request time, the number of data transfer sectors, and the location of the data transfer sectors.

7. The method according to claim 5, wherein the statistic of the load features of the data transfer commands is the average of a data transfer request time interval, the standard deviation, the median, the range of a data transfer request time interval, the number of sectors read during a unit of time, and the number of data transfer commands during a unit of time.

8. The method according to claim 5, wherein operation (c) comprises:
classifying the load feature of the data transfer command from the statistic of the load features of the data transfer commands by a classifying unit generated by learning the data transfer command of the multimedia application; and
determining whether the load of the data transfer command corresponds to the multimedia application, based on the classification of the classifying unit.

9. The method according to claim 8, wherein the data transfer command of the multimedia application is learned by a Baysian learning, neutral network, boosting, or support vector machine method.

10. A computer-readable recording medium which stores a computer program for executing the method for determining the load of a data transfer command of claim 9.

11. An apparatus for determining the load of a data transfer command in a system for transferring data to/from a disk sector according to an data transfer command provided from a disk driver, comprising:
an extracting unit which extracts the data transfer command for transferring the data to/from the disk sector from the disk driver and generates a set of data transfer commands from the extracted data transfer command;
an analyzing unit which analyzes the load feature of the extracted data transfer command based on the generated set of data transfer commands; and
a determining unit which determines whether the load of the data transfer command corresponds to a multimedia application based on the analyzed load feature of the data transfer command.

12. The apparatus according to claim 11, wherein the extracting unit comprises:
a storing unit which stores the data transfer commands for transferring the data to/from the disk sector during a first time; and
a generating unit which generates the set of data transfer commands composed of the most recent data transfer commands during a second time from among the data transfer commands stored during the first time.

13. The apparatus according to claim 12, wherein the generating unit comprises:
a first extracting unit which extracts the data transfer commands and stores them in the storing unit;
an updating unit which removes the oldest data transfer command from the data transfer commands stored during the first time and adds a new data transfer command to the data transfer commands during the first time to update the data transfer commands during the first time, if the new data transfer command is requested from the disk driver; and
a data transfer command set generating unit which generates the set of data transfer commands composed of the recent data transfer commands during the second time from among the updated data transfer commands.

14. The apparatus according to claim 13, wherein the period of the first time and the second time are equal to each other.

15. The apparatus according to claim 13, wherein the storing unit comprises:
a first storing unit which is a set of usable storage spaces; and
a second storing unit which is a set of used storage spaces.

16. The apparatus according to claim 13, wherein the analyzing unit comprises:
a second extracting unit which extracts the load features of the data transfer commands from the set of data transfer commands; and
a calculating unit which calculates a statistic of the load features of the data transfer commands from the load features of the data transfer commands.

17. The apparatus according to claim 16, wherein the load feature of the data transfer command is a data transfer request time, the number of data transfer sectors, and the location of the data transfer sectors.

18. The apparatus according to claim 16, wherein the statistic of the load features of the data transfer commands is the average of a data transfer request time interval, the standard deviation, the median, the range of a data transfer request time interval, the number of sectors read during a unit of time, and the number of data transfer commands during a unit of time.

19. The apparatus according to claim 16, wherein the determining unit comprises:
a classifying unit which learns the load feature of the data transfer command of at least one multimedia application and classifies the load feature of the data transfer command based on the learning result and the statistic of the load features of the data transfer commands; and
a load determining unit which determines whether the load of the data transfer command corresponds to the multimedia application based on the classification of the classifying unit.

20. The apparatus according to claim 19, wherein the data transfer command of the multimedia application is learned by a Baysian learning, neutral network, boosting, or support vector machine method.
